(19) United States
(12) Patent Application Publication
(10) Pub. No.: US 2004/0203305 A1
(43) Pub. Date: Oct. 14, 2004

(54) Fire and heat resistant materials

(75) Inventors: Arthur Richard Horrocks, Bolton (GB); Peter Myler, Ashton in Makerfield (GB); Baljinder Kaur Kandola, Warrington (GB); Florentina Dana Blair, Cambridge (GB)

Correspondence Address: NIXON & VANDERHYE, PC, 1100 N GLEBE ROAD, 8TH FLOOR, ARLINGTON, VA, 22201-4714, US

(73) Assignee: BTG International Limited, London (GB)

(21) Appl. No.: 10/839,264

(22) Filed: May 6, 2004

Related U.S. Application Data
(63) Continuation of application No. 10/148,970, filed on Jun. 17, 2002, now abandoned.
Application No. 10/148,970 is a 371 of international application No. PCT/GB00/04703, filed on Dec. 8, 2000.

(30) Foreign Application Priority Data
Dec. 9, 1999 (GB) 9929178.3

(51) Int. Cl. B32B 1/00; B32B 5/02; B32B 27/24

(52) U.S. Cl. 442/138; 428/920; 428/921; 156/166

(57) ABSTRACT

A rigid composite material comprising an organic fire retardant fibrous element, an intumescent material and a structure conferring amount of a cross-linkable resin is provided. When the composite material is exposed to conditions under which charring of the fire retardant fibrous element, intumescent and resin occurs, the charred surfaces of the fire retardant fibrous element intumescent and resin to bond together. Methods of preparing the composite material are also provided. The materials can be used in load bearing applications and are able to act as fire barriers under conditions of heat and flame.

The present invention relates to fire and heat resistant materials and to their use as barriers to the propagation of fire, heat and flames.

Fibre-reinforced laminate composites have become very competitive engineering materials in recent years and have successfully replaced conventional metallic and polymeric materials in many important sectors of industry. The mechanical properties of these laminate materials can be either anisotropically or isotropically tailored by the choice of fibre, matrix, interface treatment characteristics and spatial geometry. The advantages associated with these materials include a low density, high specific strength and stiffness, good corrosion resistance, and improved fatigue properties. They have thus been increasingly used in load-bearing structures such as aircraft, vehicles, ships, pipelines, storage tanks, and sports equipment. However, when these structures are exposed to conditions of flame and intense heat, their behaviour is not always predictable. This unpredictability is of particular concern for those materials used in maritime and offshore, aircraft and aerospace and modern rail applications, where the materials used must satisfy stringent requirements regarding beat and flame resistance as well as low smoke emissions. Unfortunately, many of these composite systems fail or fall short of recognised fire performance requirements or are unable to maintain their integrity upon exposure to fire or heat. This means that they are unable to contain a fire for any period of time.

Methods of fireproofing composite structures are known. One method utilises mineral and ceramic wool (Kovar and Bullock, Proc.6th Conf. Recent Advances Flame Retard. Polymeric Mat. 1993, 87-98). However these materials have the disadvantage that they are bulky, heavy and act as an absorbent for cargoes of spilt fuel or flammable liquid in a fire situation.

A second method is to use a fire-retardant paint or coating (often intumescent-based) with limited fire performance. Finally it is possible to introduce a flame-retardant additive into a matrix resin system. The latter two methods are particularly effective if the fire retardant additives are able to generate a heat and flame resistant char in their own right or are able to promote carbonisation (and hence char formation) of the composite components, usually the resin. Unfortunately in the case of coatings the protective char may detach under fire stress, whereas charring of the composite matrix will cause significant weakening of the structure in the case of the flame-retardant treated composite structure.

The term “char” is used throughout this specification to refer to the carbonised form of the polymeric (including fibrous) material produced following the application of heat to the materials herein described. Char formation usually begins at temperatures above 250° C. in the more common polymers. Initial char formation in the temperature range 250 to 350° C. is generally characterised by cross-linking reactions, which occur between aliphatic polymer chains. As the temperature rises above 350° C., the char assumes an aromatic (and often graphitic) structure. However in the presence of air, oxidation of the carbonaceous char occurs in the range 400 to 450° C. The use of the term “charring” describes the chemical and physical processes which lead to the formation of the char and the development of its structure.

Flame retardant, flexible fabrics comprising a fire retardant fibre and an intumescent material are known from EP 631515. The fabrics can be used in the manufacture of fire resistant upholstery and protective clothing. The intumescent is adhered to the fibre using a small quantity of a resinous material. The amount of binding resin present is insufficient to confer rigidity to the material. When the fabrics are exposed to conditions of intense heat and flame the surfaces of the charring fibres and intumescent bond together to give a material having unexpectedly high flame and heat barrier properties. The resin is unable to contribute to the formation of the char-bonded structure; it is merely used to bind the intumescent to the fibre. The increased amount of char produced is indicative of the ability of the material to withstand heat and act as a fire barrier. These char-bonded structures can withstand temperatures of up to 1200° C. for up to 10 minutes if the fibre and fabric structures are chosen carefully. However, these materials are not suitable for structural or load bearing applications.

For reasons of clarity, the term “char-bonding” as used herein refers to the process by which a complex char is formed between two or more independent component materials, which char by similar physical and chemical mechanisms. These otherwise independent char-forming materials interact when heated to form a complex, integrated or bonded char. The term char-bonded material therefore refers to the integrated, bonded or complex char formed on heating the component materials referred to above. The physical and chemical properties of these integrated chars have been found to be superior to the chars obtained from each of the component materials independently; compared to chars of the individual component materials, these composites are less susceptible to oxidation and are more resistant to conditions of strain and load.

Rigid composite materials having fire retardant properties are also known. GB 2052305A discloses plastic based composite articles comprising an intumescent-coated mesh embedded in a foamed plastic matrix. Although these composites display improved fire retardant properties compared to comparative compositions containing no intumescent, the fibres of the mesh, the intumescent and plastic are unable together to form a char-bonded structure upon exposure to conditions of intense heat and flame. In particular the glass and isocyanate polymers described therein are unable to form a char-bonded structure on exposure to conditions of heat and flame.

U.S. Pat. No. 5,708,065 and U.S. Pat. No. 5,859,099 disclose resin based compositions including a flame retardant additive and a reinforcing agent such as fibres of glass, carbon, mica or aramid. The components of the disclosed compositions are unable to form a char-bonded structure upon exposure to conditions of intense heat and flame.

U.S. Pat. No. 4,364,991; U.S. Pat. No. 4,308,197 and U.S. Pat. No. 4,739,115 disclose rigid composites suitable for use as structural components in aircraft applications. The composites are formed from one or more layers of a mesh formed from fibres of carbon, glass or a low melting point metal, the layers being impregnated with a resin based composition including a flare retardant such as a phosphonic acid derivative. The composite contains no intumescent components. In addition, the components of the disclosed composites are unable to form a char-bonded structure upon exposure to conditions of intense heat and flame.

A first aspect of the present invention provides a rigid composite material comprising an organic fire retardant fibre, an intumescent material and a structure conferring amount of a cross-linkable resin, characterised in that when the composite material is exposed to conditions under which charring of the fire retardant fibre, intumescent and resin occurs, the charred surfaces of the fire retardant fibre, intumescent and resin to bond together. This bonding of the charred surfaces is known as char bonding and, as indicated above, occurs when the physical and chemical char-forming actions of the material components occur simultaneously. The charred fibres produced upon exposure of the composite material to conditions of heat and flame are essentially reinforced by the char-bonding effect and provide a barrier to the propagation of heat and smoke.

The term “rigid” as used herein means that the composite is able to substantially retain its physical and structural integrity on exposure to conditions of load such as those incurred by structural elements used in road, rail, air or maritime vehicles or in the construction of buildings or other similar structures.

The materials are typically able to retain these loads at temperatures of 1000° C. for periods of up to 30 minutes and at temperatures up to 1200° C. for shorter periods. Typically the composites of the invention are exposed to loads arising from the stresses and strains imposed thereon during their use as structural elements in construction, air, rail maritime and other similar applications. The composites of the invention are typically able to withstand loads of at least 6 Gpa, 5 Gpa and 9 Gpa in flexural, torsional and compressional modes respectively. Under normal conditions the composites are able to withstand loads of 35 Gpa, 15 Gpa and 20 Gpa in flexural, torsional and compressional modes respectively. Depending upon the choice of fibres used, the composite may be able to withstand flexural loads of up to 140 to 150 Gpa.

The term “structure conferring amount” refers to the amount of resin present in the composite is sufficient to enable the composite to retain the necessary degree of structural and physical rigidity for use in the structures referred to above.

The term “simultaneously” as used herein above means that the char forming reactions of the individual components occur over the same temperature range. Preferably the char forming reactions occur at comparable rates. As indicated previously, such char-forming reactions normally occur within the temperature range of 250° C. to 350° C.

The term “reinforced” is used herein in relation to both the composite and the charred material. When this term is used in relation to the charred material it means that the char-bonded fibres present therein have a greater ability to withstand conditions of load and vibration compared to the charred fibres of the individual composite components when the char bonding property is absent. The amount of char produced upon exposure of the composite material to conditions of heat and flame provides a good indication of the level of reinforcement that a charred material is able to exhibit. When the term is used in relation to the composite (before exposure to conditions of heat and flame) it means that the presence of the reinforcing fibre component increases the magnitude of the compressive, tensile, shearing and flexural loads that the composite is able to withstand before failing.

The terms “fire retardant” and “flame retardant” are used interchangeably herein, these terms being used to describe fibre elements having a reduced tendency to ignite or burn under conditions of heat and flame as a consequence of efficient char formation.

The material of the present invention forms a fire barrier through the swelling and interactive charring of its components in fire situations. The composite materials of the invention are characterised by longer times to ignition (TTI), reduced flameout times (times for all the flames to extinguish whilst the heat flux is still incident) and reduced Peak Heat Release (PHR) rates. These fire barriers have a surprising ability to prevent or contain the spread of fire under conditions of load despite the relatively high fuel content provided by the resin component.

It has been found that the reinforcement of the char-bonded fibres produced from the materials of the present invention is greater than that of the char-bonded fibres produced upon exposure of the flexible materials of EP 631 515 to similar conditions of heat and flame. The char-bonded fibres of the present invention have also been found to be more resilient than the charred fibres of each of the individual composite components due to their ability to absorb and release energy without rupturing.

In addition the amount of char produced from the materials of the present invention and their ability to withstand oxidation above 500° C. is also surprisingly greater than that of both the individual components of the composite and the composite materials of EP 631 515. The additional percentage char produced by the composites of the invention is significant and depends, in part, upon the nature of the resin used. The increase in percentage char of 30% at 600° C. for the phenolic resins is particularly outstanding. In addition composites formed using polyester resins exhibit a significant and unexpected increase in the percentage char formed at 600° C. (as measured by thermogravimetric anaylsis, TGA), especially as polyester resin systems do not normally char during combustion.

The organic fire retardant fibre acts as a reinforcing component to enhance the strength and flexibility of the composite relative to the resin per se. The term “organic fire retardant fibre element” as used herein includes fibres that are entirely organic in nature as well as those that possess both organic and inorganic components (hereinafter referred to as hybrid fibres). Mixtures of purely organic and hybrid fibres may be present. It will be appreciated that the amount of purely organic component present in the hybrid fibre is sufficient to result in a char bonded structure when the organic fibre component of the composite comprises hybrid fibres only.

The organic fire retardant fibre elements of the invention are either inherently fire resistant or have been rendered fire resistant before or after being formed into a textile fabric. The fibre elements suitably begin to char at a temperature of from 250° C. to 330° C., preferably at a temperature of 300° C., with full char development occurring at a temperature of between 430° C. and 490° C., preferably 450° C.

Examples of suitable organic fire retardant fibrous elements include cotton, viscose and wool, all of which will normally have been rendered fire retardant by an appropriate flame retardant treatment to give the necessary degree of charring within the desired temperature range. Such treatments are well known to a skilled person.

Additional examples of suitable organic fire retardant fibrous elements include Visil (Sateri Fibres. Finland) and Viscose FR (Lenzing, Austria) both of which contain fire retardant additives introduced during fibre manufacture and which promote char formation at temperatures above 300° C. Suitable hybrid fibres include inorganic components such as silicic acid. VISIL fibres comprise 30% w/w (as silica) polysilicic acid and 70% w/v cellulose.

Other examples based on inherently fire resistant synthetic organic fibres are the poly (phenol-formaldehyde) or novoloid fibre (Kynol, Kynol Corp., Japan) and the polyaramid fibres such as Nomex (DuPont), Kevlar (DuPont) and Twaron (Acordis). Chemically treated fibres include cotton treated with a number of char-promoting, phosphorus and nitrogen-containing agents such as diammonium phosphate, ammonium polyphosphate, tetrakis (hydroxymethyl) phosphonium-urea condensates (eg Proban, Rhodia, formerly Albright and Wilson) and derivatives of phosphonic acid (eg Pyrovatex, Ciba). These chemicals are present such that the phosphorus levels comprise from 2 to 4% by weight with respect to cellulose.

A wide variety of fire retardation treatments are commercially available and are within the knowledge of a skilled person. For example, fibres may be chemically treated before, during or after processing into a textile product. Alternatively, the fibres can be flame retarded by modification of their chemical structure during manufacture or by incorporation of flame-retardant additives during manufacture.

A preferred example of an organic fibre component includes cotton to which a flame-retardant treatment has been applied at a level commensurate with a phosphorus concentration of 2.5% by weight or greater with respect to the fibre weight. As an alternative, the organic fibres may be viscose to which a flame-retardant additive has been added during the fibre production stage.

The composite of the invention may further comprise a fibre, which chars, melts or decomposes at higher temperatures than the other components of the material. This additional fibre provides further reinforcement of the composite so formed to enhance the strength and flexibility of the composite material, especially at higher temperatures. Although the inclusion of these “less compatible materials” diminishes the char bonding effect, some degree of interaction between the carbonising surfaces of the composite components and the less compatible fibre may occur, to provide some additional reinforcement to the degrading structure. The less compatible fibres may be organic, inorganic or mixed organic/inorganic (hybrid) fibres.

Examples of less compatible organic fibres include the inherently fire retardant polyaramids having a higher charring temperatures than the fire retarded fibre elements referred to above and polybenzimidazoles.

Examples of less compatible inorganic fibre components include glass, silica, alumina and carbon. These fibres preferably have a melting point at a temperature which is significantly higher than that of any organic fibre present in order to impart a high physical coherence to the composite material at higher temperatures. The inorganic component is suitably able to withstand temperatures in excess of 500° C. and is preferably able to withstand temperatures in excess of 1000° C. before melting or losing strength. Glass fibres are particularly preferred examples of the incompatible fibre; their high melting point and inorganic nature ensures physical stability and oxidative resistance respectively.

The effect of including an inorganic fibre into the material is to reinforce the material and to impede the diffusion of oxygen there through. In addition the inorganic component will create a skeletal structure, which provides the material with a thermally insulative property, even after all of the carbonaceous materials in the structure have been gasified.

Suitable hybrid fibres include inorganic components such as silicic acid. Preferred hybrid fibres include a staple viscose fibre having a silicic acid component, sold under the trademark VISIL by Sateri, Finland. Preferred VISIL fibres comprise 30% w/w (as silica) polysilicic acid and 70% w/w cellulose. As compared with a blend of simple organic and inorganic fibres, the presence of the two components in the one fibre has the advantage that during charring of the organic component, the resulting fibres possess an inorganic core. This provides a unique inorganic reinforcement to the char-bonded structure.

The organic and incompatible fibres may be formed into a woven, non-woven or knitted fabric or other appropriate array either together or individually. Other appropriate arrays include those in which the fibre component is distributed in a purely random array as well as the more ordered arrays prepared using fibrous tows. Alternatively one or both the fabric components may be used in the form of a powder. Woven fabrics are, however, preferred. The direction of orientation of the fabric layers relative to each other may be varied to produce materials having a range of strengths, flexibility and isotropy of properties. The fabric area, weave structure and fibre diameters depend upon the ultimate use of the composite and will be readily determined by a skilled person.

Alternatively the fibre components may be suspended in a resin.

In one preferred embodiment, layers of organic fire retardant fibre elements are interspersed with layers of an incompatible fibre. Composites comprising layers of Visil and glass are particularly preferred. Alternatively composites comprising kynol fibre can be used.

In an alternative embodiment the organic fire retardant element, substantially in the form of a powder, is applied to layers of woven or non-woven glass fabric before impregnation with a resin component. Preferably the organic fire retardant fibre is Visil.

The materials of the present invention are constructed so as to provide a greater or smaller degree of expansion, depending upon the application in which they are to be used. The amount of intumescent material used in the manufacture of the material will be chosen accordingly to reflect these requirements. A relatively larger expansion may be desirable, for example, in applications where a thicker heat resistant barrier to the propagation of fire at lower temperatures is required. Alternatively, the degree of expansion need only be sufficient to compensate for the reduction in the thickness of the char caused by the oxidation processes, which occur at higher temperatures. The amount of intumescent present in the material is chosen so as to confer the desired flame and heat resistant properties to the composite without compromising the mechanical strength of the material so formed.

A wide variety of intumescent systems may be used in the materials of the present invention. The particular system employed will be selected so as to ensure that the intumescent is activated at an appropriate temperature. Such systems commonly comprise an acid source, a carbonific material, a spumific compounds and optionally, a resin binder. The relative proportions of the acid source, carbonific and spumific materials used are selected to maximise the intumescent effect. The resin binder is suitably present in an amount comprising 15% w/w of the intumescent material and is sufficient to bind the latter to the fire resistant fibre surface. This resin binder should not be confused with the resin matrix used to bind the components of the composite together. Examples of useful acid sources are mono- and di-ammonium phosphates, ammonium polyphosphates, melamine phosphate, guanyl phosphate, urea phosphate, ammonium sulphate and ammonium borate. Examples of useful carbonific materials are glucose, maltose, arabinose, erythritol, pentaerthritol, di- and tri-pentaerythritol, arabitol, sorbitol, insitol and starches. Examples of spumific compounds include melamine, guanidine, glycine, urea and chlorinated paraffin. A wide variety of materials are available for use as the adhesive resin binders.

Particularly preferred intumescent materials include melamine phosphate alone or as a mixture with dipentaerythritol in a ratio of between 1:1 and 2:1. These intumescent materials are available commercially and are sold under the Trade Mark of Antiblaze NH and Antiblaze NW (Rhodia, formerly Albright and Wilson) respectively.

The weight ratio of the total fibre content to the resin is from 15:85 to 70:30, preferably from 33:66 to 50:50.

The organic fire retardant fibre comprises between 3 and 100% of the total fibre content, preferably between 7 and 60%.

As indicated above, the amount of intumescent present in the material is chosen so as to confer the desired flame and heat resistant properties to the composite without compromising the mechanical strength of the material so formed. Typical intumescent:fire retardant fibre ratios are in the range 0.2:1 to 1:1 w/w.

The resin suitably comprises between 35 and 85% w/w, preferably between 40 and 60% w/w and especially 50% w/w of the total composite material (including any intumescent present). The physical and chemical thermal degradation and char-forming actions of the resins used in the materials of the present invention preferably occur simultaneously with the other components of the material. Although any resins which are able to form a char bonded structure with the fibre and intumescent upon combustion may be used, it is preferred to use thermosetting and cross-linked resins such as epoxy, phenolic and polyester resins. Polyimide and bismaleimide resins may also be used.

The term “resin” when used in relation to the preparation of the composites denotes the resin forming components, which may be provided as one, two or more components which are combined during the preparation and may be cross-linked by application of heat or otherwise.

All the resins tested showed unexpectedly good results, particularly the epoxy and phenolic resins. The additional char of 30% obtained from the combustion of composites formed from phenolic resins at 600° C. is particularly outstanding.

In addition composites formed from the polyester resin systems have also been found to give surprisingly good results, as evidenced by the unexpected increase in percentage char associated with these composites at 600° C. Polyester resins normally show little, if any, char-burning tendencies.

The above-mentioned resins are well known to a skilled person and are typically used in the manufacture of rigid fibre-reinforced composites. They are all cross-linkable and have well documented generic chemistries.

The term “epoxy resin” is applied to both the prepolymers and to the cured resins; the former contain epoxy groups. Many of the epoxy groups are involved in the curing step, which means that the cured resin contains very few, if any, epoxy groups. During the curing step, reaction of the epoxy group with hardeners having two or more reactive functional groups results in the formation of a rigid three dimensional network, see for example Chemistry and Technology of Epoxy Resins, edited by B Ellis, Blackie Academic and Professional, 1993.

The term “phenolic resin” includes novolac and resole polymers. Novolac polymers are prepared by reacting an excess of phenol with formaldehyde in the presence of an acid catalyst to give a high melting point oligomer that is compounded with hexamethylene tetramine which decomposes at elevated temperatures to yield ammonia and formaldehyde as a crosslinking source. Resole prepolymers are formed from the reaction of phenol and formaldehyde under alkaline conditions. Upon heating condensation of hydroxymethyl groups and evolution of water causes the resin to cure, resulting in a three-dimensional network of a thermosetting material.

Polyester resins are prepared by curing a mixture of a low molecular weight unsaturated polyester dissolved in an unsaturated vinyl monomer such as styrene. Curing occurs by the polymerisation of the vinyl monomer, which forms cross-links across unsaturated sites in the polyester. Unsaturated polyester resins can be prepared from mixtures of unsaturated and saturated dibasic acids or anhydrides and diols or oxides.

The resin systems referred to above are described by BK Kandola and AR Horrocks in Flame Retardant Composites—A Review—The Potential for Use of Intumescents in Fire Retardancy of Polymers, Edited by M. LeBras, G. Camino, S. Bourbigot and R Delobel, Royal Soc. Chem., London, 1998, pp 395-417; by J. Troitzsch in International Plastics Flammability Handbook, 2^{nd} Edition. Hanser, 1990, pp 31-33; by I Hamerton in Recent Developments in Epoxy Resins. Rapra Review Reports, Vol. 8, No. 7, 1996; by A Knop and LA Pilato, Phenolic Resins, Springer-Verlag, 1985, by Macaione and Tewarson in “Flammability Characteristics of Fibre-Reinforced Composite Materials”, Chapter 32 in “Fire and polymer Hazards Identification and Prevention” edited by GL Nelson, ACS Symp. Ser. 425 ACS p 542; by Macaione in “Flammibility Characteristics of Fibre-Reinforced Composites for Combat Vehicle Applications”, Report 1992, MTL TR 92-58; by Macaione and Tewarson in J. Fire Sci., 1993, 11, 421 and “Recent Advances in the Flame Retardancy of Polymeric materials, Vol. III, ed. Lewin, 1993 Conference proceedings, Business Communications Company, Stamford, Conn., 1992, 307; by Scudamore, Fire Mater. 1994, 18, 313 and by Egglestone and Turley in Fire Mater., 1994, 18, 225. The composite material is typically cured in an autoclave or a pressure autoclave.

If the char forming reaction of the resin occurs at too low a temperature, formation of the flame-retardant intumescent textile component is less efficient and occurs independently of the decomposing resin giving rise to a structure, which is less insulative. In addition the structural stability of the complex composite is compromised as the charring does not occur in a homogeneous manner. If the resin reaction takes place too slowly or at too high a temperature, the intumescent property of the modified textile component is constrained by the still-hard, stable resin, and again the char-forming reaction will not develop efficiently, which means that the insulating fire barrier formed becomes less effective for the adjacent composite laminate.

The composite material may comprise one or more layers of a fabic formed from an intumescent treated organic fire retardant fibre. The organic fire retardant fibre layers may further comprise an incompatible fibre as defined herein above. Alternatively or in addition, the organic fire retardant fibre layers may be interleaved with one or more fabric layers formed from an incompatible fibre. In the latter case, one or both of the organic fibre layers and the incompatible fibre layers may be treated with an intumescent. Such interleaved structures incorporate fire resistance throughout the whole thickness of the composite material and maximise fire performance.

In a further embodiment the organic fire retardant fabric layers may be sandwiched between fabric formed from incompatible fibres or vice versa. Although these composites have a lower level of fire performance relative to the interleaved structures, they have the advantage of minimising any effect that the interleaved intumescent fibre layers may have on the physical and mechanical properties of the composite material. Furthermore, this sandwich geometry provides a skilled person with the possibility of introducing fire resistance to existing composites by “retro fitting” or treating that composite with resin impregnated outer layers.

The intumescent may be introduced to the composite by direct application to the fabric before impregnation with resin or in the form of a resin suspension during the resin impregnation stage.

The materials of the present invention are easily manufactured using standard techniques and a second aspect of the invention provides a method of manufacturing a rigid composite material according to the first aspect of the invention comprising impregnating an intumescent-treated fabric layer including an organic fire retardant fibre and curing the resin to produce a rigid structure. In one preferred embodiment of the second aspect of the invention, the composite materials are manufactured by overlaying two or more intumescent-treated, resin-impregnated fabric layers including an organic fire retardant fibre and curing the resin to produce a rigid structure. The fire retardant fibre layers may further comprise one or more incompatible fibre elements in their structure. Alternatively, the organic fire retardant fabric layers may be interleaved with fabric layers formed from incompatible fibre elements, optionally treated with intumescent. In a further alternative, blocks of organic fire retardant fabric layers may be placed adjacent or between blocks of fabric formed from the incompatible fibre respectively or vice versa.

In a further embodiment of the second aspect of the invention, the composites of the invention are formed by casting a suspension of the organic fire-retardant fibre and intumescent in resin and curing the resin. The fire retardant preferably comprises short fibre lengths of 1 mm or less.

In a still further embodiment of the second aspect of the invention, the materials of the invention are manufactured by overlaying fabric layers of the organic fire retardant or incompatible fibre elements respectively impregnated with a resin suspension of a fire-retardant fibre element. Examples of fibres suitable for use in the manufacture of the composites of the invention are provided herein above.

In the manufacture of the composite materials according to the second aspect of the invention the resin suspension may be applied to the fibre-reinforcing either before or after these elements are overlaid. The intumescent material may be present in association with one or more of the fibre layers or with the fibre in suspension. Alternatively the intumescent may itself be introduced as a suspension in the resin.

Preferably the fabric layers are impregnated with resin before they are interleaved. The use of resin impregnated fabric layers greatly facilitates the production of composite materials having a range of shapes and configurations.

In addition the intumescent material may be applied to the fabric before resin impregnation. Alternatively, the intumescent material may be added to the resin before the “impregnation” stage. If desired a mixture of intumescent and the fire retardant fibre (in lengths of 1 mm or less) may be mixed to a suspension or paste with resin before being used to impregnate the fibre reinforcing elements.

In a preferred embodiment of the second aspect of the invention the rigid composite materials of the present invention may be manufactured by interleaving layers of intumescent treated fabric with layers of fabric not so treated, impregnating the interleaved layers with resin and curing the composite. Alternatively, the fabric layers are arranged so that non-intumescent fabric layers are positioned between intumescent treated outer fabric layers before the material is impregnated with resin.

The composite materials of the invention are used in the manufacture of structural components for use in air and space, maritime, off-shore, civil engineering and construction, rail and automotive applications. A third aspect of the invention therefore provides a structural component comprising a composite material according to the first aspect of the invention.

A further aspect of the invention provides a structure including a composite material according to the first aspect of the invention. The term structure includes stationary structures such as temporary and permanent buildings as well as vehicular structures such as aircraft, marine, road and rail vehicles.

A still further aspect of the invention provides a method of fireproofing a vehicle or other similar structure comprising the step of fitting to said vehicle a rigid composite material according to the first aspect of the invention.

The invention will now be described with reference to the following non-limiting figures and examples. Variations on these falling within the scope of the present invention will be apparent to a skilled person.

### FIGURES

FIG. 1 illustrates a cross-section of a structure according to one embodiment of the invention.

FIG. 2 illustrates a cross-section of a structure according to a further embodiment of the invention.

FIG. 3 discloses the results of a Differential Thermal Analysis (DTA) of Crystic 471 PAL V resin (resin A) ( [symbol] ), a four layered composite according to the invention formed from resin A and Visil NW fibre ( - - - ) and a four layered composite according to the invention formed from resin A and Visil NH fibre ( . . . ). The abscissa represents temperature in ° C. and the ordinate represents the temperature difference in ° C./mg⁻¹.

FIG. 4 discloses the results of a Thermal Gravimetric Analysis (TGA) of Crystic 471 PAL V resin (resin A) ( [symbol] ), a four layered composite according to the invention formed from resin A and Visil NW fibre ( - - - ) and a four layered composite according to the invention formed from resin A and Visil NH fibre ( . . . ). The abscissa represents temperature in ° C. and the ordinate represents the weight in %.

FIG. 5 discloses the results of a Differential Thermal Analysis (DTA) of Crystic 491 PA resin (resin B) ( [symbol] ), a four layered composite according to the invention formed from resin B and Visil NW fibre ( - - - ) and a four layered composite according to the invention formed from resin B and Visil NH fibre ( . . . ). The abscissa represents temperature in ° C. and the ordinate represents the temperature difference in ° C./mg⁻¹.

FIG. 6 discloses the results of a Thermal Gravimetric Analysis (TGA) of Crystic 491 PA resin (resin B) ( [symbol] ), a four layered composite according to the invention formed from resin B and Visil NW fibre ( - - - ) and a four layered composite according to the invention formed from resin B and Visil NH fibre ( . . . ). The abscissa represents temperature in ° C. and the ordinate represents the weight in %.

FIG. 7 illustrates the additional char formation associated with the four layer resin-fibre composites of the invention. ( - - - ) represents the composite formed from resin A and Visil NW. ( . . . ) represents the composite formed from resin A and Visil NH. ( [symbol] ) represents the composite formed from resin B and Visil NW. ( [symbol] ) represents the composite formed from resin B and Visil NH.

FIG. 8 illustrates how the rate of heat release varies with time for samples comprising resin A ( - - - ); resin A and Visil fabric ( . . . ); resin A and Antiblaze-NW impregnated Visil fabric ( [symbol] ); resin A and Antiblaze-NH impregnated Visil fabric ( [symbol] ); and resin A and glass ( [symbol] ). The ordinate represents heat release rate (HRR) in kW/m⁻² and the abscissa represents the time in seconds.

FIG. 9 indicates the amount of smoke (l/s) released over time for samples comprising resin A ( - - - ); resin A and Visil ( . . . ); resin A and Antiblaze-NH impregnated fabric ( [symbol] ); resin A and Antiblaze-NH impregnated fabric ( [symbol] ); and resin A and glass ( [symbol] ). The abscissa represents the time in seconds and the ordinate represents the amount of smoke released in litres per second (l/s).

FIG. 10 indicates the amount of smoke released over time for samples comprising resin B ( - - - ); resin B and Visil ( . . . ); resin B and Antiblaze-NH impregnated Visil fabric ( [symbol] ); resin B and Antiblaze-NH impregnated Visil fabric ( [symbol] ); and resin B and glass ( [symbol] ). The abscissa represents time in seconds and the ordinate represents the amount of smoke released in litres per second (l/s).

FIG. 11 indicates the residual mass of the original sample left at 5 minutes after ignition for samples comprising resin B (column 1); resin B and Visil (column 2); resin B and Antiblaze-NW impregnated Visil fabric (column 3); resin B and Antiblaze-NH impregnated Visil fabric (column 4) and resin B and Visil (column 5).

FIG. 12 illustrates how the rate of heat release (HRR) varies with time for samples comprising 4 layers of woven glass (300 g m⁻²) impregnated with resin A ( [symbol] ); 4 layers of woven glass (300 m⁻²) impregnated with resin A and Antiblaze-NH intumescent (10% w/w resin) ( . . . ); 4 layers of woven glass (300 gm⁻²) impregnated with resin A, Antiblaze-NH intumescent (10% w/w resin) and Visil powder (10% w/w resin) ( [symbol] ); and 2 layers of Antiblaze-NH impregnated Visil fabric (240 gm⁻²) interleaved between 3 layers of woven glass (300 gm⁻²), the interleaved layers being impregnated with resin A ( [symbol] ). The abscissa represents the time in seconds (s) and the ordinate represents the heat release rate (HRR) in kw/m⁻².

FIG. 13 illustrates how the rate of heat release (HRR) varies with time for samples comprising 8 layers of woven glass (300 gm⁻²) impregnated with B3B epoxy resin ( [symbol] ); 8 layers of woven glass (300 gm⁻²) impregnated with B3B epoxy resin and Antiblaze-NH intumescent (10% w/w resin) ( . . . ); and 8 layers of woven glass (300 gm⁻²) impregnated with B3B epoxy resin; Antiblaze-NH intumescent (10% w/w resin) and Visil powder (10% w/w resin) ( [symbol] ). The abscissa represents the time in seconds and the ordinate represents the heat release rate (HRR) in kw/m⁻².

FIG. 14 indicates how the mass of the composite changes with time after ignition for samples comprising 8 layers of woven glass (300 gm⁻²) impregnated with B3B epoxy resin ( [symbol] ); 8 layers of woven glass (300 gm⁻²) impregnated with B3B epoxy resin and Antiblaze-NH intumescent (10% w/w resin) ( . . . ); and 8 layers of woven glass (300 gm⁻²) impregnated with B3B epoxy resin; Antiblaze-NH (10% w/w resin) and Visil powder (10% w/w resin) ( [symbol] ). The abscissa represents the time in seconds and the ordinate represents the residual mass (%).

FIG. 15 discloses the results of a Differential Thermal Analysis (DTA) for composites comprising B3 epoxy resin, Kynol fibres and Antiblaze NH. The abscissa respresents the temperature in ° C. and the ordinate represents the temperature difference in

FIG. 16 discloses the results of a Thermal Gravimetric Analysis (TGA) for composites comprising B3 epoxy resin, Kynol fibres and Antiblaze NH. The abscissa respresents the temperature in ° C. and the ordinate represents the weight in %.

FIG. 17 discloses the results of a Differential Thermal Analysis (DTA) for composites comprising K6541 phenolic resin, Kynol fibre and Antiblaze NH. The abscissa respresents the temperature in ° C. and the ordinate represents the temperature difference in ° C./mg⁻¹.

FIG. 18 discloses the results of a Thermal Gravimetric Analysis (TGA) for composites comprising K6541 phenolic resin, Kynol fibre and Antiblaze NH. The abscissa respresents the temperature in ° C. and the ordinate represents the weight in %.

The structure of FIG. 1 comprises a series of interleaved resin-impregnated reinforcing layers (1) sandwiched between one or more interleaved layers of intumescent-resin impregnated reinforcing layers (2).

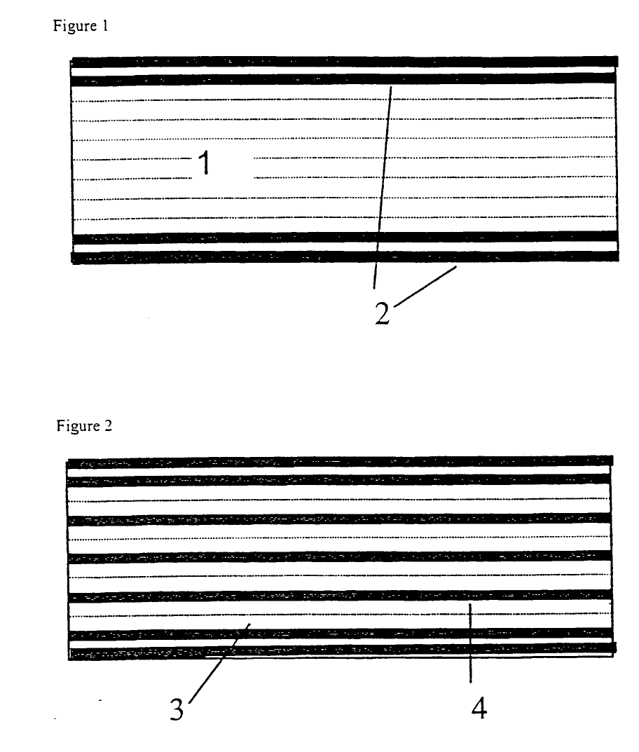

The structure of FIG. 2 comprises a series of resin-impregnated reinforcing layers (3) interleaved with layers of intumescent-resin impregnated reinforcing layers (4).

Both the sandwich structure of FIG. 1 and the interleaved structure of FIG. 2 have a thickness of from 2 to 20 mm, preferably from 4 to 10 mm.

The rigid composite materials of the present invention are prepared by overlaying layers of resin-impregnated and intumescent-resin impregnated fabric and curing the resin. It will be appreciated that, by using this technique, it is possible to prepare planar or shaped structures as desired by placing the resin-impregnated layers in an appropriately shaped mould.

### EXAMPLES

### Example 1

### Preparation of Model Composite Materials

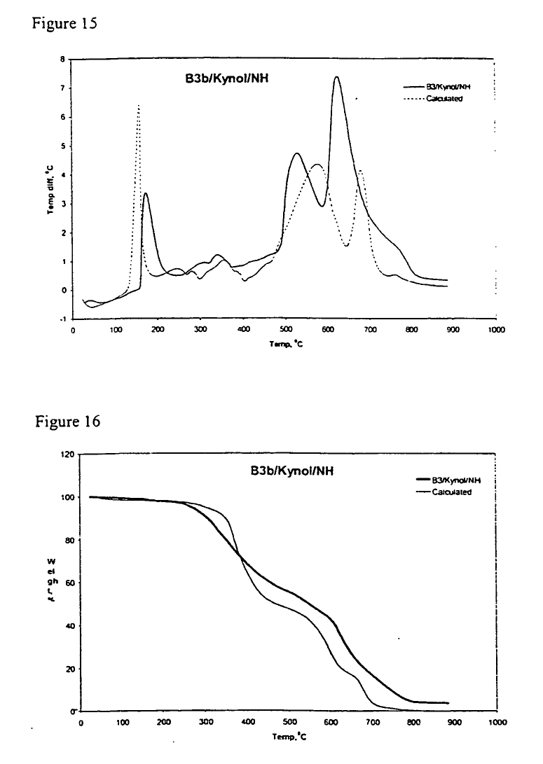

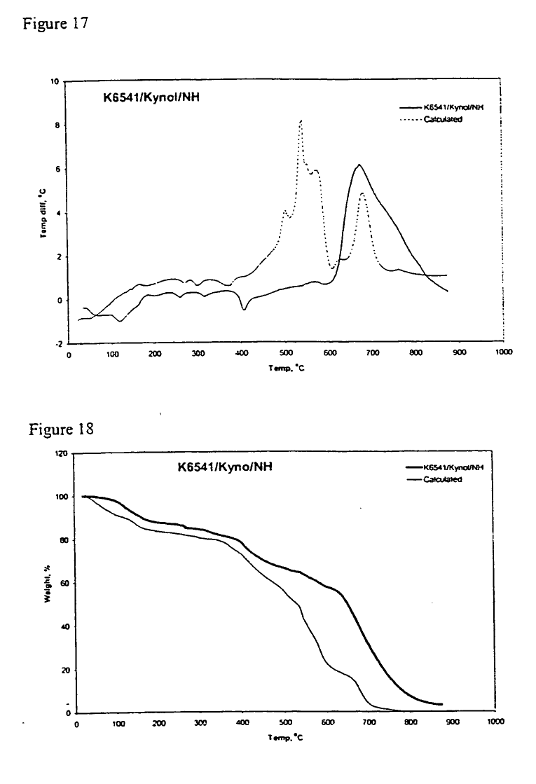

A number of resins and intumescents were selected and used to prepare models of composite materials as described above; these materials are listed below. The model composite materials were prepared as 1:0.5:0.5 (w/w) mixtures of resin:Visil fibre:intumescent or resin:Kynol fibre:intumescent and were analysed using thermal analysis (10 mg samples in flowing air. 100 ml min⁻¹ at 10° C. min⁻¹) to assess the char-forming behaviour of combinations with respect to both the individual components and the composite materials of EP 631 515. The results are presented below. Additional results for systems containing Kynol fibre are shown in FIGS. 15 to 18.

Results

It was found that for a number of resin/fibre/intumescent combinations (including the non-char-forming polyester resins) the amounts of char produced as well as their ability to withstand oxidation above 500° C. were greater than expected with respect to both the averaged individual component behaviour as well as the behaviour of the composites of EP 631 515. The additional percentage char produced by the composites of the invention is significant and depends, in part, upon the nature of the resin used. The increase in percentage char of 30% at 600° C. for the phenolic resins is particularly outstanding. In addition composites formed using polyester resins exhibit a significant and unexpected increase in the percentage char formed at 600° C. (as measured by thermogravimetric anaylsis, TGA), especially as polyester resin systems do not tend to char during combustion. It therefore appears that these systems are able to confer considerable fire resistance to components in which they are present. Resin-intumescent, and in some cases Visil fibre combinations which show this behaviour are as follows:

Resins

Polyester Resins (Scott Bader)

1. Crystic 2414PA (orthophthalic)

2. Crystic 471 PALV (orthophthalic)

3. Crysic 491 PA (isophthalic)

4. Crystic 199 (isophthalic)

Epoxy Resins (Hexcel Composites)

1. B1—model formulation with Bis-A epoxy resin

(resin DER 332 (86.9 parts)/dicyandiamide hardener DICY (7.4 parts)/accelerator Diuron (3.7 parts)/Aerosil 200 (silica additive) (2.0 parts))

2. B2-model formulation with trifunctional epoxy resin

3. B3 modification of B2 formulation

4. B4-modification of B1 formulation

Phenolic (Resole) Resins (Hexcel Composites)

1. DDP 5235 (Dynochem UK)

2. Durez 51010

3. XDF 4329

4. K6541

5. DIR 33136

Epoxy resin formulation B1 was prepared by combining the DICY and Diuron components (supplied by Trade Micronising Ltd. and Hodgson Specialities respectively) with a small quantity of DER332 (supplied by Dow Chemicals) and mixed with a high speed disperser to disperse the powders in the liquid resin. The remaining DER332 was stirred with the Aerosil 200 (supplied by Degussa) until well mixed and then combined with the DICY/diuron/DER332 mixtures to form a homogeneous mixture. All the mixing was carried out at room temperature. The resulting mixture was stored in a freezer in a closed container at approximately −20° C. and was fully defrosted before opening the container.

Intumescents (Rhodia Consumer Specialities, formerly Albright & Wilson)

Antiblaze NW (melamine phosphate and dipentaerythritol in a ratio between 1:1 and 2:1).

Antiblaze NH (melamine phosphate)

Table 1 shows the additional char produced at various temperatures over the predicted amount of char produced from the composite materials of EP 631 515 and resins indicated.

TABLE 1
Char enhancement of resin - intumescent combinations

| | Additional char, % | | | |
|---|---|---|---|---|
| System | 500° C. | 600° C. | 700° C. | 800° C. |
| Polyester resins/Visil/ | | | | |
| Antiblaze NW | | | | |
| Crystic 2-414PA | 9.8 | 9.2 | 2.6 | 2.2 |
| Crystic 471 PALV | 12.4 | 15.8 | 13.6 | 3.3 |
| Crystic 491 PA | 11.1 | 13.5 | 10.3 | 2.4 |
| Crystic 199 | 10.3 | 12.6 | 8.2 | 4.1 |
| Polyester resins/Visil/ | | | | |
| Antiblaze NH | | | | |
| Crystic 2-414PA | 9.1 | 12.4 | 12.1 | 3.7 |
| Crystic 471 PALV | 7.4 | 12.4 | 12.3 | 3.9 |
| Crysic 491 PA | 10.7 | 15.8 | 15.2 | 3.5 |
| Crystic 199 | 11.1 | 16.1 | 16.0 | 6.0 |
| Epoxy resins/Visil/ | | | | |
| Antiblaze NW | | | | |
| B1 - Bis-A epoxy resin | 6.6 | 7.8 | 1.5 | −0.4 |
| B2 - trifunctional epoxy resin | 3.7 | 11.1 | 2.5 | 0.2 |
| B3 - modification of B2 | 4.1 | 11.5 | 5.6 | 2.6 |
| B4 - modified B1 trifunctional | 1.4 | 6.5 | −2.3 | −2.7 |
| resin | | | | |
| Epoxy resins/Visil/ | | | | |
| Antiblaze NH | | | | |
| B1 - Bis-A epoxy resin | 6.7 | 15.5 | 9.5 | 2.2 |
| B2 - trifunctional epoxy resin | 7.6 | 19.2 | 9.2 | 5.9 |
| B3 - modification of B2 | 7.7 | 18.5 | 14.1 | 7.4 |
| B4 - modification of B1 | 3.5 | 15.3 | 6.3 | −0.2 |
| Epoxy resin/Kynol/ | | | | |
| Antiblaze NH | | | | |
| B3 - modification of B2 | 7.8 | 15.6 | 12.9 | 4.2 |
| Phenolic (Resole) resins/Visil/ | | | | |
| Antiblaze NW | | | | |
| DDP 5235 | 11.7 | 29.7 | −0.1 | 1.1 |
| Durez 51010 | 19.6 | 27.7 | −0.6 | 1.8 |
| XDF 4329 | 7.8 | 27.9 | −1.5 | −1.9 |
| K6541 | 8.5 | 29.0 | 0.9 | 0.1 |
| DIR 33136 | 8.8 | 27.1 | −2.0 | 0.1 |
| Phenolic (Resole) resins/Visil/ | | | | |
| Antiblaze NH | | | | |
| DDP 5235 | 11.6 | 33.2 | 14.5 | 5.7 |
| Durez 51010 | 19.9 | 31.2 | 17.4 | 4.9 |
| XDF 4329 | 9.5 | 32.4 | 28.8 | 5.5 |
| K6541 | 7.6 | 29.9 | 2.7 | 2.2 |
| DIR 33136 | 11.5 | 34.9 | 7.7 | 4.8 |
| Phenolic (Resole) resin/Kynol/ | | | | |
| Antiblaze NH | | | | |
| K6541 | 9.0 | 30.3 | 29.0 | 8.8 |

### Example 2

### Preparation of Polyester Resin Composites

A 120 gm⁻² non-woven needle-punched web of Visil fibres was coated with intumescent (50% intumescent with respect to fibre weight) suspended in a Vinamul 3303 resin (Vinamul Ltd., UK) at 15% (w/w) of binder resin with respect to intumescent. Two sets of four layers of the intumescent treated fabric were impregnated with the polyester resins Crystic 471 PALV (A) and Crystic 491 PA (B) respectively, pressed to the same thickness and cured at room temperature for 48 h to give the laminated resin composites. The composites thus produced were analysed by thermal analytical studies.

Thermal Analytical Studies

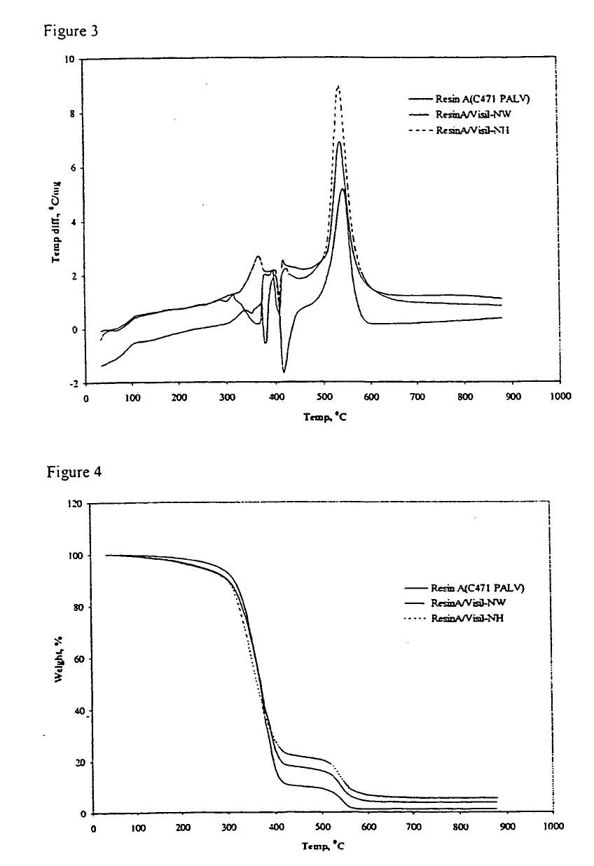

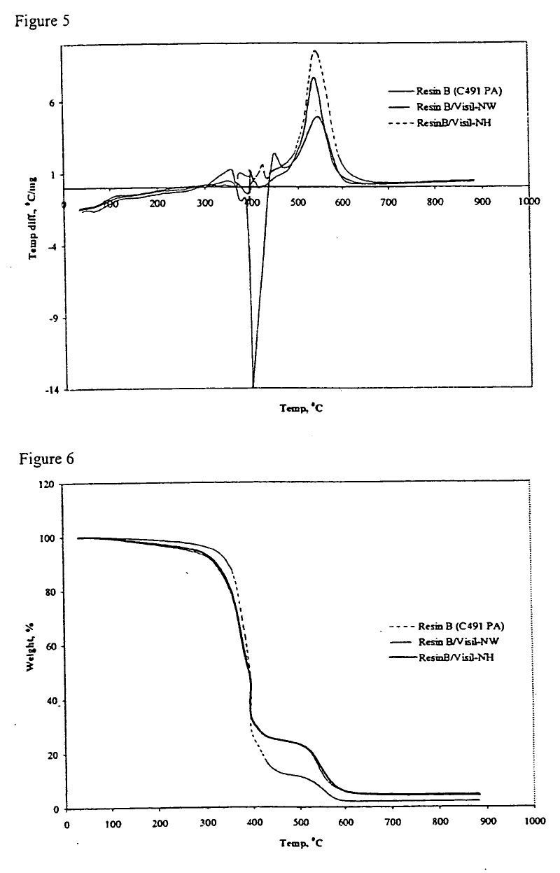

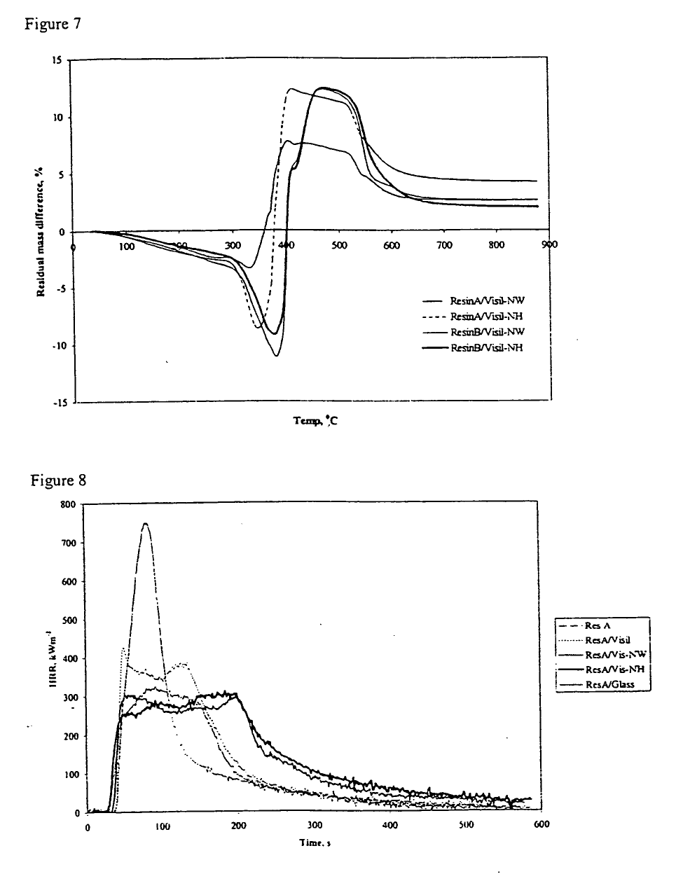

Differential Thermal Analysis (DTA) and Thermal Gravimetric Analysis (TGA) results of the resins A and B (Crystic 471 PALV and Crystic 491 PA) only as well as the laminate materials formed from the resins (A) or (B) with the Visil-NW and Visil-NH fabrics are shown in FIGS. 3 to 6. The results are quite different and the additional char residues associated with the composite materials at temperatures above 400° C. are more thermally stable than from those of resin only. The residual char mass differences versus temperature for composites with respect to resin from TGA curves are plotted in FIG. 7. Table 2 shows the additional char produced at selected temperatures with respect to the respective resin only. The laminate materials form significantly more char at temperatures of between 400-600° C.

TABLE 2
Char enhancement of resin/Visil - intumescent combinations

| | Additional char, % | | | |
|---|---|---|---|---|
| System | 500° C. | 600° C. | 700° C. | 800° C. |
| ResinA/Visil - NW (4.2:1) | 6.9 | 3.1 | 2.6 | 2.5 |
| ResinA/Visil - NH (4.3:1) | 11.2 | 5.5 | 4.4 | 4.2 |
| ResinB/Visil - NW (3.2:1) | 11.7 | 3.6 | 2.7 | 2.6 |
| ResinB/Visil - NH (3.2:1) | 12.0 | 3.6 | 2.2 | 2.0 |

### Examples 3 to 7

The burning behaviour of a number of experimental composites comprising glass and/or Visil fibre or powder and/or intumescent in combination with either a polyester or an epoxy resin were investigated using cone calorimetry. In each of examples 3 to 7 a Fire Testing Technology Ltd cone calorimeter conforming to and used in accordance with ISO 5660: 1993 was used. 100×100 mm samples of each of the experimental composites were exposed to a heat flux of 50 kw/m⁻². Once exposed to the heat flux, the following parameters were determined:

TTI (Time to Ignition (s))—this increases for more fire resistant materials.

Flameout(s)—this is the time for all flames to extinguish whilst the heat flux is still incident. Shorter times indicate a greater fire resistance.

PHR (Peak Heat Release Rate (kw/m⁻²))—this is the maximum intensity of heat emitted following ignition of the target specimen. A low PHR value indicates a greater fire resistance.

THR (Total Heat Released (MJ/m⁻²))—this is the total heat released by the heated sample. It provides a measure of the fuel content of the sample and whether the fuel is prevented from burning.

Smoke (sm²/s/m² unitless)—this is measured in terms of total cumulative smoke optical density.

Mass rate loss—measured in terms of the residual mass as a percentage of the original mass presents in the sample at a time (t) after ignition.

LOI (limited oxygen index (%))—measured in accordance with ASTM D2863-77—indicates the minimum oxygen levels necessary to support combustion of the composite material.

From the results of examples 3 to 7 it can be seen that the introduction of a Visil-intumescent combination, either as a pulverised mixture or as a coated fabric, gives rise to the reduction of the PHR values by providing an internal char-bonded structure which impedes the burning of the resin. The results of the TGA studies in examples 1 and 2 support the observation of increased char formation. This is also supported by the increased mass retention data obtained during the cone calorimetry experiments.

### Example 3

Composites (G2, G4, G6 and G8) containing 2, 4, 6 and 8 layers of random 400 gm⁻² glass fibre matting impregnated with the orthophthalic polyester resin, Crystic 471 PALV were prepared. These glass/resin composites can be used for control purposes and can be used for comparison purposes in assessing the composites of the invention. The TTI, flameout, PHR, THR and smoke values were recorded for each of the composites prepared using a cone calorimeter as previously described. The results, shown in Table 3 illustrate that the flame retardant properties of the composite are dependent on the thickness of the composite. An increase in thickness leads to a corresponding increase in the TTI values and a decrease in the PHR value of the composite.

TABLE 3

| | | | Approximate | | | | | | |
|---|---|---|---|---|---|---|---|---|---|
| | W+ fraction (%) | | ratio | Thickness | TTI | Flameout | PHR | THR | |
| SAMPLE | glass | resin | glass:resin | (mm) | (s) | (s) | (KW/m²) | (MJ/m²) | Smoke |
| G2 | 40.2 | 59.8 | 2:3 | 1.4 | 17 | 428 | 450 | 27 | 1336 |
| G4 | 40.4 | 59.6 | 2:3 | 2.7 | 35 | 464 | 313 | 52 | 2801 |
| G6 | 40.3 | 59.7 | 2:3 | 4.1 | 40 | 660 | 308 | 74 | 3849 |
| G8 | 42.0 | 58.0 | 2:3 | 5.7 | 45 | 811 | 261 | 108 | 5323 |

### Example 4

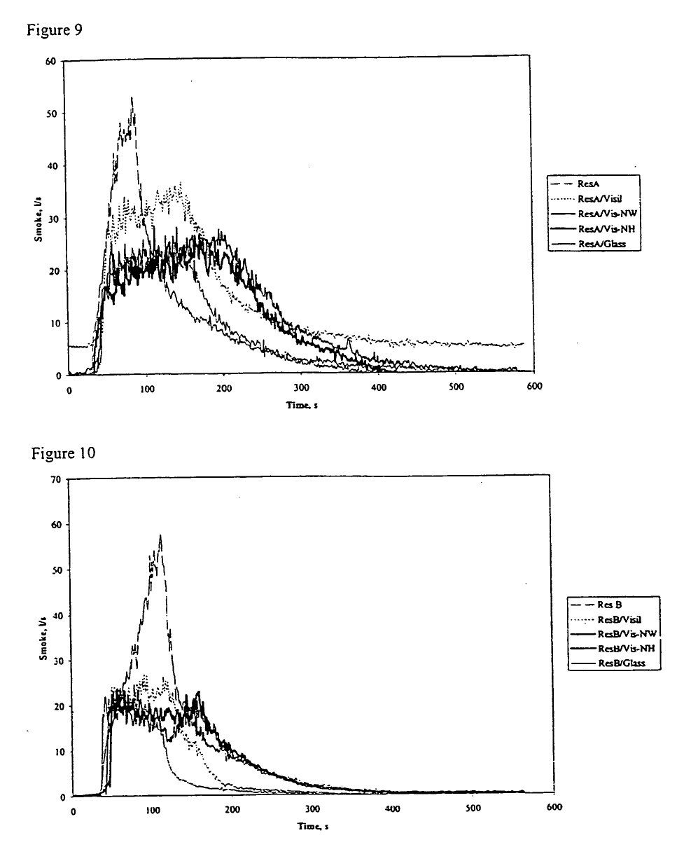

Rigid composite materials comprising either an orthophthalic Crystic 471 PALV polyester resin (Resin A) or an isophthalic Crystic 491 PA polyester resin (Resin B) and a fibre web selected from a non woven glass web (450 gm⁻²), a non woven web of Visil (120 gm⁻²) and a non woven web of Visil (180 gm⁻²) impregnated with an intumescent selected from Antiblaze NW and Antiblaze NH (50% w/w of the fibre) and Vinamul 3303 resin (15% w/w of the intumescent). The composites were prepared by impregnating four layers of each respective fabric other than glass with each resin, pressing the four layers to the same thickness and curing at room temperature for 48 h. In the case of the non-woven glass web, only a single layer of fabric was used. Cone calorimetry studies were carried out as described previously and the results are shown in table 4 and FIGS. 8 to 11.

From the results it appears that the introduction of Visil fibre only to either resin A or B decreases each of the flameout time, the amount of smoke released as well as the PHR and THR values. The further addition of intumescents (Antiblaze NW or Antiblaze NH) further reduces the PHR values of the composites and does not greatly affect the flameout time. Addition of intumescent increases the TTI value for composites formed from resin B. The differences in TTI values between the Visil-intumescent composites formed from resins A and B may be due, in part, to the larger proportion of resin present in the composites formed from resin A.

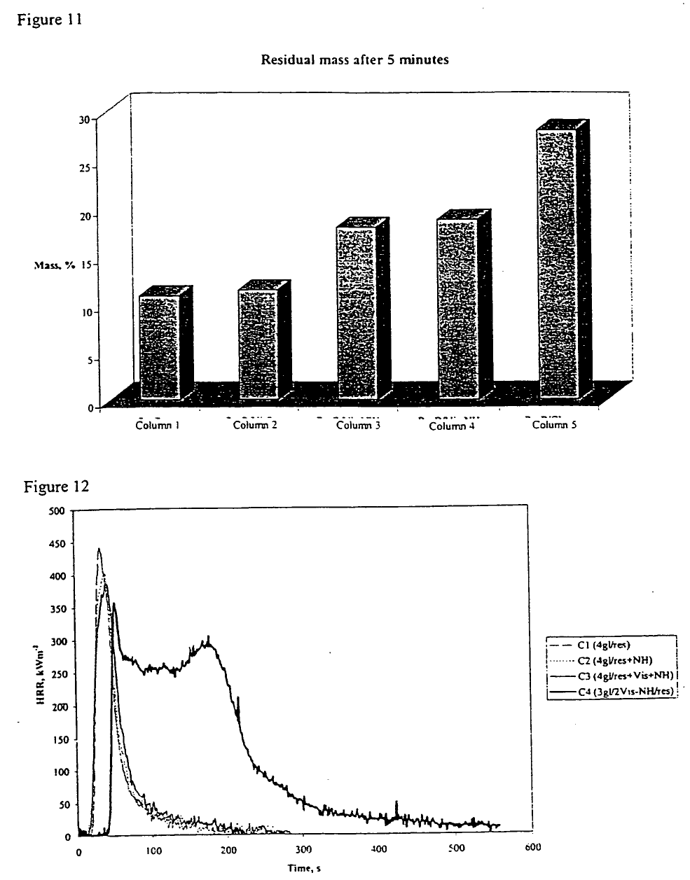

The mass loss (or retention) curves obtained concurrently during cone calorimetric studies show that greater mass residues at a given time (FIG. 11) are produced in the presence of Visil/intumescent combinations, which supports the TGA results of examples 1 and 2.

It can therefore be seen that the composites of the invention provide rigid materials having fire-retardant properties comparable to a better than corresponding composites formed from glass and resin only.

TABLE 4

| | Wt Fraction (%) | | | Resin:Fibre | Thickness | TTI | Flameout | PHR | THR | | |
|---|---|---|---|---|---|---|---|---|---|---|---|
| SAMPLE | Resin | Fibre | Intumescent | ratio | (mm) | (s) | (s) | (kW/m² | (MJ/m²) | Smoke | LOI % |
| Resin A | 100 | | | | 2.2 | 29 | 609 | 750 | 58 | 4217 | 18.0 |
| Resin A/Visil | 85.6 | 14.4 | | 6:1 | 2.8 | 44 | 601 | 425 | 62 | 7566 | 18.8 |
| Resin A/Visil- | 80.8 | 12.8 | 6.4 | 19:3 | 3.3 | 38 | 622 | 305 | 70 | 5808 | 20.6 |
| NW | | | | | | | | | | | |
| Resin A/Visil- | 81.3 | 12.2 | 6.1 | 20:3 | 3.4 | 30 | 662 | 311 | 78 | 4872 | 20.9 |
| NH | | | | | | | | | | | |
| Resin A/glass | 85.8 | 14.2 | | 6:1 | 2.2 | 43 | 521 | 324 | 51 | 3847 | 18.3 |
| Resin B | 100 | | | | 2.9 | 34 | 606 | 1134 | 71 | 4660 | |
| Resin B/Visil | 80.6 | 19.4 | | 4:1 | 2.0 | 21 | 457 | 603 | 49 | 1776 | |
| Resin B/Visil- | 76.0 | 16 | 8 | 19:4 | 2.6 | 41 | 614 | 495 | 61 | 3096 | |
| NW | | | | | | | | | | | |
| Resin B/Visil- | 76.6 | 15.6 | 7.8 | 19:4 | 2.8 | 46 | 604 | 456 | 58 | 3328 | |
| NH | | | | | | | | | | | |
| Resin B/glass | 80.3 | 19.7 | | 4:1 | 1.5 | 36 | 337 | 489 | 37 | 1816 | |

### Example 5

Rigid composite materials (C1 to C4) having the compositions given below were prepared by impregnating four or more fabric layers with the orthophthalic polyester resin Crystic 471 PALV (Resin A), pressing the layers together and curing at room temperature for 48 hours.

| SAMPLE | COMPOSITION |
|---|---|
| C1 | 4 layers of woven glass (300 gm⁻²) impregnated with |
| | Crystic 471 PALV (Resin A) |
| C2 | 4 layers of woven glass (300 gm⁻²) impregnated with |
| | Crystic 471 PALV (Resin A and Antiblaze NH (10% w/w |
| | resin) |
| C3 | 4 layers of woven glass (300 gm⁻²) impregnated with |
| | Crystic 471 PALV (Resin A), Visil powder (10% w/w resin) |
| | and Antiblaze NH (10% w/w resin) |
| C4 | 3 layers of woven glass (300 gm⁻²) and 2 layers of |
| | impregnated non-woven Visil fabric (240 gm⁻²) |
| | impregnated with Crystic 471 PALV (Resin A). The |
| | non-woven Visil fabric was prepared by applying to the |
| | non-woven Visil fabric (120 gm⁻²) the intumescent |
| | Antiblaze NH (100% w/w fibre) and Vinamul 3303 resin |
| | (15% w/w intumescent). The Vinamul 3303 resin causes the |
| | intumescent to adhere to the Visil fabric. |

The TTI; flameout; PHR; THR and smoke values were recorded for each of the composites C1 to C4 using a cone calorimeter as previously described and the results are shown in Table 5 and FIG. 12.

From the results it appears that the addition of intumescent and Visil/intumescent (either as a mixture (C3) or as a treated fabric (C4) progressively reduces PHR values (FIG. 12). The flameout times; TTI and THR values of C2 and C3 are similar to those of the glass/resin composite (C1). The increase in the flameout time and TTI and THR values associated with C4 may be due, in part, to the relatively high proportion of resin present in the C4 samples compared to the samples C1 to C3.

The composites of the invention including an intumescent, a fire retardant fibrous (Visil) and a resin exhibit improved fire resultant properties compared to composites lacking an intumescent and a fire-retardant fibrous element.

TABLE 6

| SAM- | Wt fraction (%) | | | | Resin:Fibre | Resin:glass | Glass:Visil | Thickness | TTI | Flameout | PHR | THR | |
|---|---|---|---|---|---|---|---|---|---|---|---|---|---|
| PLE | Resin | Glass | Visil | Intumescent | ratio | ratio | ratio | (mm) | (s) | (s) | (kW/m²) | (MJ/m²) | Smoke |
| R1 | 60.1 | 39.9 | — | — | 3:2 | 3:2 | — | 2.7 | 41 | 472 | 335 | 52 | 2660 |
| R2 | 64.2 | 29.5 | — | 6.3 | 2:1 | 2:1 | — | 3.8 | 37 | 662 | 300 | 76 | 3977 |
| R3 | 62.0 | 24.8 | 6.1 | 6.1 | 2:1 | 5:2 | 6:1 | 4.6 | 23 | 643 | 234 | 75 | 5018 |
| R4* | 72.5 | 19.2 | 4.15 | 4.15 | 3:1 | 7:2 | 5:1 | 5.0 | 30 | 944 | 271 | 103 | 5382 |

*Visil-NH fabric

Example 6

Rigid Composite materials (R1 to R6) having the compositions given below were prepared by impregnating four or more layers with the orthophthalic polyester resin Crystic 471 PALV (Resin A). The layers were pressed together and cured at room temperature for 48 hours. The TTI; flameout; PHR; THR and smoke values were recorded for each of the composite R1 to R6 using a cone calorimeter as previously described and the results are shown in Table 6. Additional smoke data is shown in Table 6a.

| SAMPLE | COMPOSITION |
|---|---|
| R1 | 4 layers of random glass (400 gm⁻²) impregnated with |
| | Crystic 471 PALV (Resin A) |
| R2 | 4 layers of random glass (400 gm⁻²) impregnated with |
| | Crystic 471 PALV (Resin A) and Antiblaze NH (10% w/w |
| | resin) |
| R3 | 4 layers of random glass (400 gm⁻²) impregnated with |
| | Crystic 471 PALV (Resin A), Visil powder (10% w/w resin) |
| | and Antiblaze NH (10% w/w resin) |
| R4 | 3 layers of random glass (400 gm⁻²) and 2 layers of |
| | Antiblaze NH impregnated non-woven Visil fabric (240 gm⁻²) |
| | impregnated with Crystic 471 PALV (Resin A). The |
| | non-woven Visil fabric was prepared by applying to the |
| | non-woven intumescent impregnated Visil fabric (120 gm⁻²) |
| | the intumescent Antiblaze NH (100% w/w fibre) and |
| | Vinamul 3303 resin (15% w/w intumescent). The Vinamul |
| | 3303 resin causes the intumescent to adhere to the Visil fabric. |

From the results it can be seen that the addition of intumescent (Antiblaze-NH) and Visil/intumescent (either as a powder mixture or in the form of a woven fabric) progressively reduces the PHR values of the composites. Increasing the thickness of the composite (to 4.5-5 mm) does not influence the order of the PHR-reducing effect.

The TTI, flameout, THR and smoke values observed for composites R2 to R5 may be due, in part, to the high proportion of resin present in these samples.

TABLE 5

| SAM- | Wt fraction (%) | | | | Resin:Fibre | Resin:glass | Glass:Visil | Thickness | TTI | | PHR | THR | |
|---|---|---|---|---|---|---|---|---|---|---|---|---|---|
| PLE | Resin | Glass | Visil | Intumescent | ratio | ratio | ratio | (mm) | (s) | Flameout | (kW/m²) | (MJ/m²) | Smoke |
| C1 | 37.3 | 62.7 | | | 4:7 | 4:7 | | 1.0 | 24 | 207 | 443 | 14 | 607 |
| C2 | 38.8 | 57.2 | | 3.8 | 2:3 | 2:3 | | 1.2 | 19 | 214 | 402 | 16 | 737 |
| C3 | 42.2 | 49.6 | 4.1 | 4.1 | 4:5 | 1:1 | 12:1 | 1.5 | 22 | 239 | 387 | 17 | 754 |
| C4* | 65.1 | 21.7 | 6.6 | 6.6 | 16:7 | 3:1 | 3:1 | 4.3 | 48 | 543 | 356 | 58 | 2891 |

*Visil-NH fabric

TABLE 6A
NBS smoke test under flaming conditions. Test duration 4 minutes (240 s).
ASTM E662 Standard Test Method for Specific Optical DS after 4 mins.
Density of Smoke Generated by solid materials

| | | | | | | | | Smoke |
|---|---|---|---|---|---|---|---|---|
| | Wt fraction (%) | | | | Thickness | Max. Specific | Time to | obscuration |
| Samples | Glass | Resin | Visil | Int | (mm) | Optical density | Ds = 16(s) | index |
| Glass + Resin | 39.9 | 60.1 | — | — | 2.7 | 687.52 | 40 | 170153 |
| Glass + Resin + Antiblaze NH | 29.5 | 64.2 | — | 6.3 | 3.8 | 623.51 | 28 | 204538 |
| Glass + Resin + Visil + Antiblase NH | 25.8 | 62.0 | 6.1 | 6.1 | 4.6 | 230.76 | 54 | 16821 |

| | | | | | | | |
|---|---|---|---|---|---|---|---|
| Glass + Visil Antiblaze NH* + Resin | 19.2 | 72.5 | 8.3# | 5.0 | 503.26 | 38 | 88453 |

*Visil NH Fabric

### Example 7

Rigid composite materials (E1 to E5) having the compositions given below were prepared as follows: samples E1 to E3 were prepared by impregnating glass fabric with resin and any additive specified. The individual resin-impregnated fabric layers were dried in an oven at 40° C. for 10 minutes. The requisite number of layers for the samples E1 to E3 were stacked, laid up in a vacuum bag and cured at 135° C. in an oven for 1 hour.

Samples E4 and E5 were prepared by placing each layer of glass or Visil between two pre-prepared resin films. The resin was adhered to the fabric by using an iron as a heat source and the protective paper applied to the exposed surface of the resin was removed. The requisite number of resulting layers were stacked as indicated, laid up in a vacuum bag and cured at 185° C. in an oven for 1 hour.

| SAMPLE | COMPOSITION |
|---|---|
| E1 | 8 layers of woven glass (300 gm⁻²) impregnated with Epoxy B3B |
| | resin |
| E2 | 8 layers of woven glass (300 gm⁻²) impregnated with Epoxy B3B |
| | resin and Antiblaze-NH (10% w/w resin) |
| E3 | 8 layers of woven glass (300 gm⁻²) impregnated with Epoxy B3B |
| | resin, Antiblaze-NH (10% w/w resin) and Visil powder (10% w/w resin) |
| E4 | 3 layers of Antiblaze-NH impregnated non-woven Visil fabric |
| | (240 gm⁻²) interleaved between 4 layers of woven glass (300 gm⁻²), |
| | the layers of Visil and glass each being positioned between Epoxy |
| | B3B resin layers (as described above). The non-woven Antiblaze- |
| | NH impregnated Visil-fabric was prepared by applying to a non- |
| | woven Visil fabric (120 gm⁻²) the intumescent, Antiblaze-NH, (100% w/w fibre) |
| | and Vinamul 3303 resin (15% w/w intumescent). |
| E5 | 3 layers of woven glass (300 gm⁻²) interleaved between 4 layers of |
| | Antiblaze-NH impregnated non-woven Visil fabric (240 gm⁻²), the |
| | layers of Visil and glass each being positioned between Epoxy B3B |
| | resin layers (as described above). The non-woven Antiblaze-NH |
| | impregnated Visil fabric was prepared by applying to a non-woven |
| | Visil fabric (120 gm⁻²) the intumescent, Antiblaze-NH (100% w/w |
| | fibre) and Vinamul 3303 resin (15% w/w intumescent). The vinamul |
| | 3303 resin causes adherence of the intumescents to the Visil fabric. |

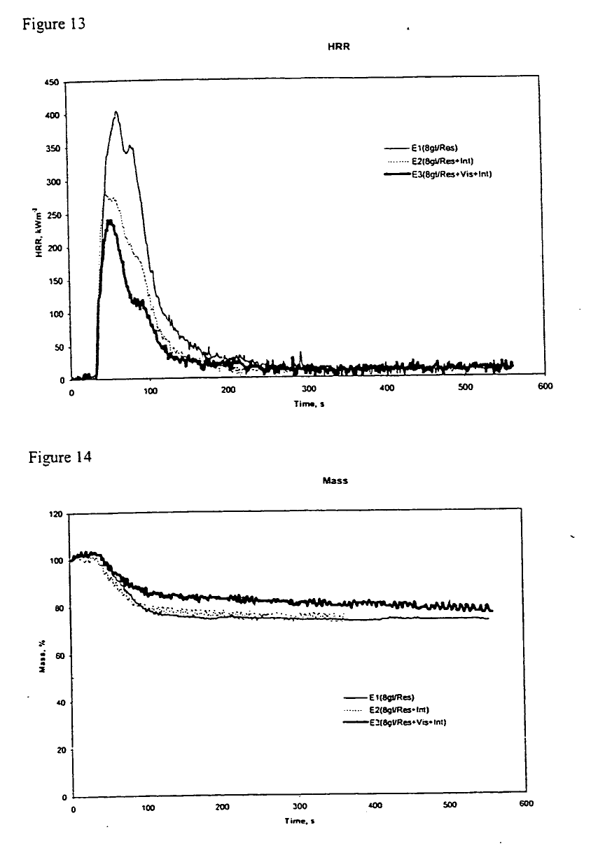

The TTI, flameout, PHR, THR and smoke values were recorded for each of the composites E1 to E5 using a cone calorimeter as previously described and the results are shown in Table 7. The HRR mass loss rate of the sample under these conditions was also determined and the results are shown in FIGS. 13 and 14.

From the results it can be seen that the addition of Visil and Visil-intumescent (the Visil being in both powdered and fabric form) reduces the PHR values. The reduction THR for samples E1 to E3 indicates that the char-forming activity of the resin-Visil-intumescent combination is reducing the overall fuel loading for these samples. The total smoke values are also reduced for samples E2 to E4. The mass loss rate of the resin-Visil-intumescent combination (E3) is less than those of samples E1 and E2 (FIG. 14). These results support the TGA derived enhanced char results obtained in Examples 1 and 2 and suggest that char-bonding is more significant in the epoxy resin composites compared to the polyester resin composites.

TABLE 7

| SAM- | Wt fraction (%) | | | | Resin:Fibre | Resin:glass | Glass:Visil | Thickness | TTI | Flameout | PHR | THR | |
|---|---|---|---|---|---|---|---|---|---|---|---|---|---|
| PLE | Resin | Glass | Visil | Intumescent | ratio | ratio | ratio | (mm) | (s) | (s) | (kW/m²) | (MJ/m²) | Smoke |
| E1 | 45 | 55 | — | — | 9:11 | 9:11 | — | 1.9 | 39 | 246 | 404 | 31 | 1097 |
| E2 | 42.3 | 53.0 | — | 4.7 | 5:6 | 5:6 | — | 2.0 | 35 | 193 | 285 | 20 | 688 |
| E3 | 40.0 | 50.0 | 5.0 | 5.0 | 9:11 | 4:5 | 10:1 | 2.3 | 38 | 220 | 240 | 18 | 704 |
| E4* | 46.7 | 33.3 | 10.0 | 10.0 | 1:1 | 4:3 | 3:1 | 2.1 | 38 | 224 | 356 | 26 | 714 |
| E5 | 47.5 | 25.4 | 13.55 | 13.55 | 6:5 | 2:1 | 1:1 | 2.4 | 46 | 300 | 365 | 33 | 1042 |

*Visil-NH fabric

1. A rigid composite material comprising an organic fire retardant fibrous element, an intumescent material and a structure conferring amount of a cross-linkable resin, characterised in that when the composite material is exposed to conditions under which charring of the fire retardant fibrous element, intumescent and resin occurs, the charred surfaces of the fire retardant fibrous element, intumescent and resin bond together.

2. A rigid material according to claim 1, which further comprises an incompatible fibre element.

3. A rigid material according to claim 1, in which the organic fire retardant fibre comprises a hybrid fibre.

4. A rigid material according to claim 1, in which the organic fire retardant fibre is inherently fire retardant or is treated with a fire retardant.

5. A rigid material according to claim 1, in which the intumescent material is selected from melamine phosphate and/or dipentaerythritol.

6. A rigid material according claim 1 in which the resin is a thermosetting resin.

7. A rigid material according to claim 1, in which the resin is selected from one or more of a char forming or non-char forming polyester, epoxy and phenolic resin.

8. A rigid composite material according to claim 1, which comprises at least two layers, wherein at least one of the layers comprises a layer of an intumescent-resin impregnated fabric.

9. A rigid material according to claim 8, which further comprises one or more layers of a resin impregnated fabric, said one or more additional layers being other than an intumescent-resin impregnated fabric.

10. A rigid material according to claim 8, which comprises one or more layers of a non-intumescent resin impregnated fabric interleaved with one or more layers of an intumescent-resin impregnated fabric.

11. A rigid material according to claim 9, which comprises one or more layers of a non-intumescent resin impregnated fabric placed between one or more layers of an intumescent-resin impregnated fabric.

12. A rigid material according to claim 8, in which the impregnation medium comprises a resin suspension of a fire retardant fibre and an intumescent.

13. A rigid material according to claim 1, in which the resin includes a suspension of the fire retardant fibre and the intumescent.

14. A rigid composite material according to claim 1, which comprises a cured resin suspension of the fire retardant fibre and the intumescent.

15. A method of manufacturing a rigid composite material according to claim 1 comprising the steps of overlaying one or more layers of a resin impregnated fire-retardant fibre and curing the resin, wherein in at least one or more of the fire-retardant fibres layers includes an intumescent treated fibre element.

16. A method according to claim 15 in which the fibre layers further comprise one or more layers of a resin impregnated additional fibre element, the said one or more additional layers optionally including an intumescent.

17. A method according to either claim 15, in which the fabric layers are impregnated with resin subsequent to being overlaid.

18. A method according to claim 15, in which the resin comprises a suspension of a fire retardant fibre element.

19. A method according to claim 15, in which the resin includes a suspension of an intumescent.

20. A method of manufacturing a rigid composite according to claim 1, comprising the steps of casting a suspension of a fire retardant fibre and an intumescent and curing the resin suspension.
